(19) United States
(12) Patent Application Publication
(10) Pub. No.: US 2018/0218333 A1
(43) Pub. Date: Aug. 2, 2018

(54) SENTIMENT ANALYSIS OF COMMUNICATION FOR SCHEDULE OPTIMIZATION

(71) Applicant: International Business Machines Corporation, Armonk, NY (US)

(72) Inventors: Christine A. Jenkins, Attadale (AU); Mihir J. Mehta, Perth (AU); Adam J. Pilkington, Eastleigh (GB); Travis K. Thorne, Padbury (AU); Michael L. Wager, South Lake (AU)

(21) Appl. No.: 15/422,510

(22) Filed: Feb. 2, 2017

(51) Int. Cl. G06Q 10/10; H04L 29/08; G06N 99/00; G06F 17/27

(52) U.S. Cl. CPC G06Q 10/1095; G06F 17/279; G06N 99/005; H04L 67/22

(57) ABSTRACT

An input from a user is received. The input includes two or more first users, a time frame for monitoring one or more first electronic communications between the two or more first users, and a method for determining an overall sentiment score of the one or more first electronic communications. The one or more first electronic communications between the two or more first users are monitored. One or more first related electronic communications in the one or more first electronic communications are determined using cognitive analysis and natural language processing. A meeting is determined in the one or more related electronic communications. An overall sentiment score is determined for the determined meeting.

### BACKGROUND

The present invention relates generally to the field of electronic communication, and more particularly to optimizing meeting schedules based on sentiment analysis of electronic communication.

Businesses use several forms of electronic communication including e-mail, instant messaging (IM), short message service (SMS) texting, multimedia messaging service (MMS) texting, team rooms, and the like. Electronic communication allow company employees to keep one another informed of information, such as company projects, and activities, such as meetings between the company employees, in an easy to use, convenient manner. The forms of electronic communication used by businesses also provide an electronic record of each communication, which allows for retrieval of communications made in the past (last week, last month, last year, etc.).

### SUMMARY OF THE INVENTION

Embodiments of the present invention include a method, computer program product, and system for optimizing meeting schedules based on sentiment analysis of electronic communication. In one embodiment, an input from a user is received. The input includes two or more first users, a time frame for monitoring one or more first electronic communications between the two or more first users and a method for determining an overall sentiment score of the one or more first electronic communications. The one or more first electronic communications between the two or more first users are monitored. One or more first related electronic communications in the one or more first electronic communications are determined using cognitive analysis and natural language processing. A meeting is determined in the one or more related electronic communications. An overall sentiment score is determined for the determined meeting.

### BRIEF DESCRIPTION OF THE DRAWINGS

FIG. 1 depicts a functional block diagram of a computing environment, in accordance with an embodiment of the present invention;

FIG. 2 depicts a flowchart of a program for optimizing meeting schedules based on sentiment analysis of electronic communication, in accordance with an embodiment of the present invention; and

FIG. 3 depicts a block diagram of components of the computing environment of FIG. 1, in accordance with an embodiment of the present invention.

### DETAILED DESCRIPTION

Embodiments of the present invention provide for optimizing meeting schedules based on sentiment analysis of electronic communication. Employees are required to attend many meetings during the course of company business. Meetings with management, weekly status meetings on projects, training meetings, and emergency meetings on issues are only some of the meetings that require employee attendance. In some cases, employees are spread across a company campus and attending a meeting may require a long walk or even a short drive to the location where the meeting is being held. Inefficiencies may arise if employees attend meetings that end up being shortened or even cancelled after the employees arrive at the meeting location. Also, meeting times may be extended if issues arise that are not known by all of the attendees. And new meetings may be scheduled during an existing meeting if the right people are not in attendance in the current meeting.

Embodiments of the present invention recognize that there may be a method, computer program product, and computer system for optimizing meeting schedules based on sentiment analysis of electronic communication. In an embodiment, sentiment analysis (also known as opinion mining) refers to the use of Natural Language Processing (NLP), text analysis and computational linguistics to identify and extract subjective information in source materials. Sentiment analysis is widely applied to reviews and social media for a variety of applications, ranging from marketing to customer service. Sentiment analysis aims to determine the attitude of a speaker or a writer with respect to some topic or the overall contextual polarity of a document. The attitude may be his or her judgment or evaluation, affective state (i.e., the emotional state of the author when writing), or the intended emotional communication (i.e., the emotional effect the author wishes to have on the reader). The method, computer program product and computer system may use cognitive analysis and natural language processing to analyze electronic communication between employees and based on the analysis, recommend changes to meeting duration and the attendee list for the meeting.

The present invention will now be described in detail with reference to the Figures.

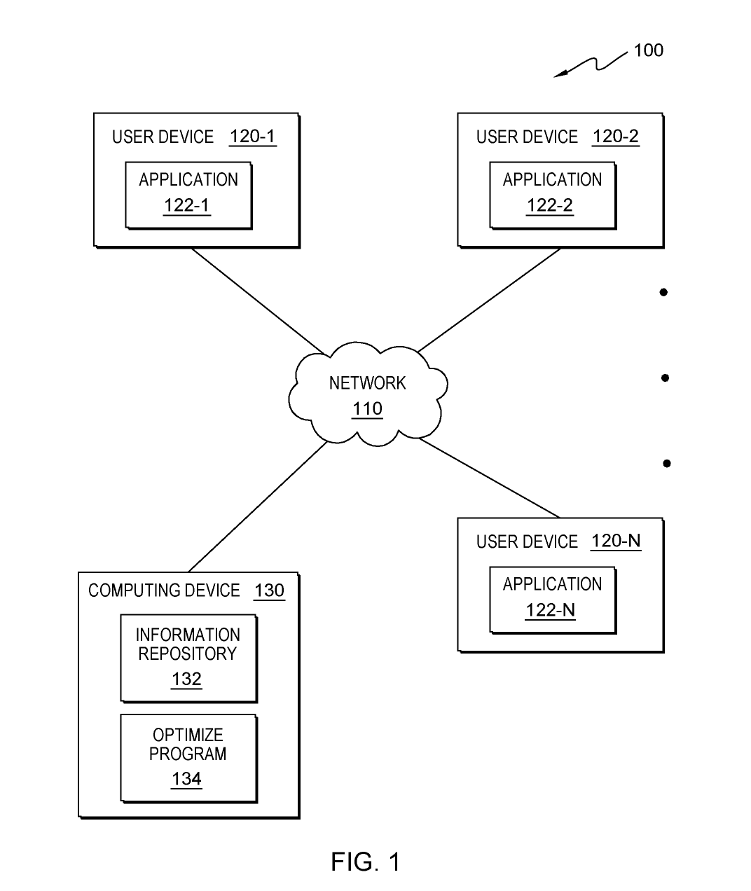

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes user device 120-1, user device 120-2, user device 120-N, and computing device 130, connected to network 110. In example embodiments, computing environment 100 may include other computing devices (not shown in FIG. 1) such as smartwatches, cell phones, smartphones, wearable technology, phablets, tablet computers, laptop computers, desktop computers, other computer servers or any other computer system known in the art, interconnected with user device 120-1, user device 120-2, user device 120-N, and computing device 130 over network 110.

In embodiments of the present invention, user device 120-1, user device 120-2, user device 120-N, and computing device 130 may connect to network 110, which enables user device 120-1, user device 120-2, user device 120-N, and computing device 130 to access other computing devices and/or data not directly stored on user device 120-1, user device 120-2, user device 120-N, and computing device 130. Network 110 may be, for example, a short-range, low power wireless connection, a local area network (LAN), a telecommunications network, a wide area network (WAN) such as the Internet, or any combination of the three, and include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between user device 120-1, user device 120-2, user device 120-N, computing device 130, and any other computing devices connected to network 110, in accordance with embodiments of the present invention. In an embodiment, data received by another computing device (not shown in FIG. 1) in computing environment 100 may be communicated to user device 120-1, user device 120-2, user device 120-N, and computing device 130 via network 110.

In embodiments of the present invention, user device 120-1 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. User device 120-2 and user device 120-N are substantially similar to user device 120-1. In an embodiment, computing environment 100 includes user device 120-N that may represent any number of user devices. For ease of reading this document, user device 120-N will be used to reference any instance of user device 120-1, user device 120-2, etc.

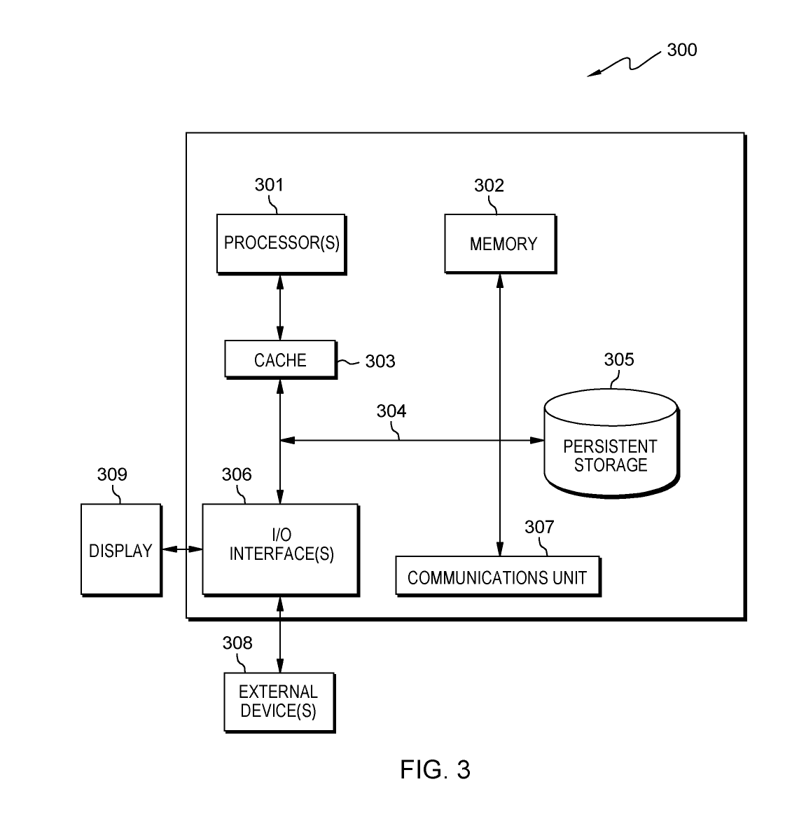

In certain embodiments, user device 120-N represents a computer system utilizing clustered computers and components (e.g., database server computers, application server computers, etc.) that act as a single pool of seamless resources when accessed by elements of computing environment 100. In general, user device 120-N is representative of any electronic device or combination of electronic devices capable of executing computer readable program instructions. User device 120-N may include components as depicted and described in further detail with respect to FIG. 3, in accordance with embodiments of the present invention.

According to an embodiment of the present invention, user device 120-N includes application 122-N. For ease of reading this document, application 122-N will be used to reference any instance of application 122-1, application 122-2, etc. In an embodiment, application 122-N may be an application used for electronic communication between company employees. Examples of application 122-N include e-mail applications, calendar applications, instant messaging (IM) applications, short message service (SMS) text applications, multimedia messaging service (MMS) text applications, team room applications, phone calls (using voice recognition and/or converting speech to text for analysis), and the like.

In embodiments of the present invention, computing device 130 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, computing device 130 represents a computer system utilizing clustered computers and components (e.g., database server computers, application server computers, etc.) that act as a single pool of seamless resources when accessed by elements of computing environment 100. In general, computing device 130 is representative of any electronic device or combination of electronic devices capable of executing computer readable program instructions. Computing environment 100 may include any number of computing device 130. Computing device 130 may include components as depicted and described in further detail with respect to FIG. 3, in accordance with embodiments of the present invention.

In an embodiment, computing device 130 includes information repository 132 and optimize program 134. In another embodiment, information repository 132 and/or optimize program 134 may be included on user device 120-N or any other computing device accessible via network 110.

According to embodiments of the present invention, information repository 132 may be storage that may be written to and/or read by optimize program 134. In one embodiment, information repository 132 resides on computing device 130. In other embodiments, information repository 132 may reside on user device 120-N or on any other device (not shown in FIG. 1) in computing environment 100, in cloud storage or on another computing device accessible via network 110. In yet another embodiment, information repository 132 may represent multiple storage devices within computing device 130. Examples of data stored to information repository 132 include records of electronic communication between people using user device 120-N, sentiment scores determined by optimize program 134, and information and/or parameters used to determine said sentiment scores.

In an embodiment, information repository 132 may be implemented using any volatile or non-volatile storage media for storing information, as known in the art. For example, information repository 132 may be implemented with a tape library, optical library, one or more independent hard disk drives, multiple hard disk drives in a redundant array of independent disks (RAID), solid-state drives (SSD), or random-access memory (RAM). Similarly, information repository 132 may be implemented with any suitable storage architecture known in the art, such as a relational database, an object-oriented database, or one or more tables. In an embodiment of the present invention, application 122-N, optimize program 134, and any other programs and applications (not shown) operating on user device 120-N and/or computing device 130 may store, read, modify, or write data to information repository 132.

According to embodiments of the present invention, optimize program 134 may be a program, a subprogram of a larger program, an application, a plurality of applications, or mobile application software, which functions to optimize meeting schedules based on sentiment analysis of electronic communication. In an embodiment, a meeting may be a work meeting. In another embodiment, a meeting may be an event. In yet another embodiment, a meeting may be any gathering of people getting together for any purpose. A program is a sequence of instructions written by a programmer to perform a specific task. Optimize program 134 may run by itself but may be dependent on system software (not shown in FIG. 1) to execute. In one embodiment, optimize program 134 functions as a stand-alone program residing on computing device 130. In another embodiment, optimize program 134 may work in conjunction with other programs, applications, etc., found in computing environment 100. In yet another embodiment, optimize program 134 may be found on other computing devices (not shown in FIG. 1) in computing environment 100, which are interconnected to computing device 130 via network 110.

In an embodiment, optimize program 134 may receive input from a user. In an embodiment, optimize program 134 may monitor electronic communications. In an embodiment, optimize program 134 may determine people included in the electronic communication. In an embodiment, optimize program 134 may determine at least one related electronic communication. In an embodiment, optimize program 134 may determine a sentiment score. In an embodiment, optimize program 134 may determine if the sentiment score is “neutral”. In response to determining that the sentiment score is “neutral”, optimize program 134 may store information. In response to determining that the sentiment score is not “neutral”, optimize program 134 may determine if the sentiment score is “good”. In response to determining that the sentiment score is “good”, optimize program 134 may recommend an adjustment to a meeting and may store information. In response to determining that the sentiment score is not “good”, optimize program 134 may determine new people to invite to a meeting, may recommend an adjustment to a meeting, and may store information.

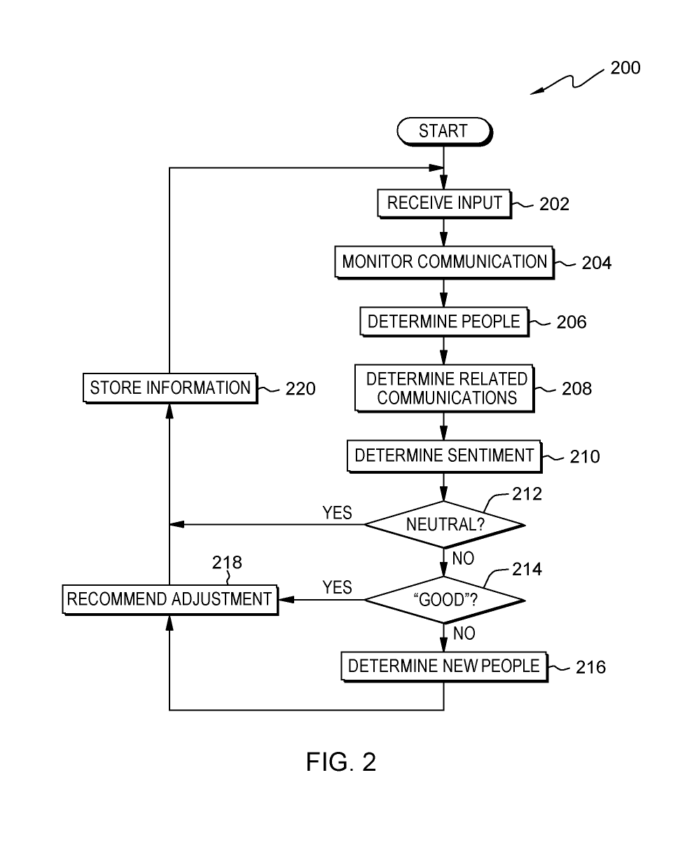

FIG. 2 is a flowchart of workflow 200 depicting a method for optimizing meeting schedules based on sentiment analysis of electronic communication. In one embodiment, the method of workflow 200 is performed by optimize program 134. In an alternative embodiment, the method of workflow 200 may be performed by any other program working with optimize program 134. In an embodiment, a user, via a user interface (not shown in FIG. 1), may invoke workflow 200 upon opening an application such as application 122-N. In an alternative embodiment, a user may invoke workflow 200 upon accessing optimize program 134.

In an embodiment, optimize program 134 receives input (step 202). In other words, optimize program 134 receives input from at least one user defining parameters for use by optimize program 134. In an embodiment, parameters include a method for scoring sentiment (e.g., a value between plus five and minus five, “good”/“neutral”/“bad”, green/yellow/red), a time frame for monitoring electronic communication (e.g., all related electronic communication, electronic communication within a calendar month, a rolling two week time frame, electronic communication of specific topics), and names of people to include in or exclude from the electronic monitoring (e.g., individuals, individuals included in one or more teams, relationships between individuals such as employee-employee, employee-team lead, employee-manager, employee-upper level manager, etc., and job responsibilities between the individuals such as engineering, management, human resources, etc.). In an embodiment, people may be employees in a company. In another embodiment, people may be a group of family and/or friends. In yet another embodiment, people may be any group of people communicating via any method of electronic communication known in the art. In an embodiment, an employee inputs via user device 120-N that a plus five to minus five range will be used to score sentiment and that all electronic communication in the company of the employee will be monitored. For example, “Ann” uses a company laptop to input a sentiment scoring between plus five and minus five and also inputs that all company electronic communication should be monitored. In another embodiment, optimize program 134 receives no user input resulting in default parameter values being used to monitor electronic communication and score sentiment.

In an embodiment, optimize program 134 monitors electronic communication (step 204). In other words, optimize program 134 monitors electronic communication between people per the default parameter values or the user input parameter values as provided in step 202. In an embodiment, optimize program 134 monitors employee communications sent via e-mail, IM, SMS, MMS, team rooms, and the like. In an embodiment, optimize program 134 on computing device 130 monitors company e-mail traffic sent by user device 120-N over network 110. For example, e-mails sent between company employees, each using a company laptop connected to an internal network, is monitored.

In an embodiment, optimize program 134 determines people (step 206). In other words, optimize program 134 determines the people sending and receiving the electronic communication. In an embodiment, optimize program 134 determines the people by monitoring the names in the “to:” courtesy copy (“cc:”), and blind courtesy copy (“bcc:”) address fields within the electronic communication. In the embodiment, optimize program 134 may use a company directory to correlate an e-mail address (e.g., “jonesa@company.com”) to an actual name of a user (e.g., “Ann Jones”). In another embodiment, in addition to monitoring the address fields, optimize program 134 monitors the electronic communication for names not found within the address fields of the electronic communication. In an embodiment, optimize program 134 on computing device 130 monitors electronic communication via application 122-N between five instances of user device 120-N connected to network 110 and determines the names of the employees using the five instances of user device 120-N. For example, “Ann”, “Bob”, “Cal”, “Deb”, and “Ed” are sending e-mails using an e-mail application over the company intranet regarding a weekly status meeting.

In an embodiment, optimize program 134 determines related electronic communications (step 208). In other words, optimize program 134 determines other communication related to the electronic communication currently being monitored. In an embodiment, the determination is made by matching the names determined in step 206 to identify other electronic communication with the same distribution. In another embodiment, the determination is made by monitoring the subject line of the electronic communication to identify other electronic communication with the same subject line content. In yet another embodiment, the determination is made by analyzing the content within the electronic communications using cognitive analysis and NLP analysis to identify other electronic communication with related content. In an embodiment, optimize program 134 determines related electronic content stored to information repository 132 on computing device 130. For example, related electronic content concerning the weekly status meeting is determined from the electronic communication(s) stored to the memories of the five company laptops.

In an embodiment, optimize program 134 determines sentiment (step 210). In other words, optimize program 134 uses natural language processing (NLP) and cognitive analysis to analyze the monitored electronic communication in order to determine a sentiment score. In an embodiment, NLP is a field of computer science, artificial intelligence, and computational linguistics concerned with the interactions between computers and human (natural) languages, both common language and regional slang (i.e., informal language). As such, NLP is related to the area of human-computer interaction. Many challenges in NLP involve natural language understanding, that is, enabling computers to derive meaning from human or natural language input, and others involve natural language generation. In an embodiment, cognitive analysis involves self-learning systems that use data mining, pattern recognition and NLP to mimic the way the human brain works. The goal of cognitive analysis is to create automated information technology systems that are capable of solving problems without requiring human assistance. Cognitive analysis systems use machine learning algorithms. Such systems continually acquire knowledge from the data fed into them by mining data for information. The systems refine the way they look for patterns and as well as the way they process data so they become capable of anticipating new problems and modeling possible solutions. In an embodiment, optimize program 134 on computing device 130 determines a sentiment score of minus four for a weekly status meeting. For example, based on the monitored and stored electronic communications, a sentiment score of minus four is determined for the weekly status meeting owned by “Ann”.

In an embodiment, optimize program 134, based on NLP and cognitive analysis, determines a sentiment score of minus one, zero, or plus one when the following words or phrases are included in the electronic communication(s): neutral, average, fair, normal, typical, status quo, no change, little change, nothing new, minor update, do not care, not my field of expertise, and the like. For example, “The test resulted in average scores” would yield a “neutral” sentiment score of minus one, zero, or plus one. In the example, “a bit higher than average” may be a sentiment score of plus one and “a bit lower than average” may be a sentiment score of minus one. In another embodiment, a sentiment score of minus one, zero, or plus one may be considered neutral. In yet another embodiment, a sentiment score of minus one, zero, or plus one may be considered “yellow”.

In an embodiment, optimize program 134, based on NLP and cognitive analysis, determines a sentiment score of plus two or plus three when the following words or phrases are included in the electronic communication(s): non-issue, concurrence, agree, good, positive, happy, satisfied, acceptable, favorable, satisfactory, approve, resolved, amicable, complimentary, emoticons such as “ :-) “, and the like. For example, “The customer found our proposal acceptable.” would yield a “good” sentiment score of plus two or plus three.

In an embodiment, optimize program 134, based on NLP and cognitive analysis, determines a sentiment score of plus four or plus five when the following words or phrases are included in the electronic communication(s): very good, extremely happy, excellent, superior, top notch, exceptional, exemplary, magnificent, extraordinary, superlative, first class, world class, ecstatic, and the like. For example, “Your performance this quarter was exceptional.” would yield a “very good” sentiment score of plus four or plus five.

In an embodiment, a sentiment score of plus two or plus three may be considered “good”. In another embodiment, a sentiment score of plus four or plus five may be considered “very good”. In yet another embodiment, a sentiment score of plus two, plus three, plus four, or plus five may be considered “green”.

In an embodiment, optimize program 134, based on NLP and cognitive analysis, determines a sentiment score of minus two or minus three when the following words or phrases are included in the electronic communication(s): issue, concern, controversy, bad, negative, unhappy, unsatisfied, awful, unacceptable, unfavorable, unsatisfactory, poor, near failing, problem, obstacle, trouble, emoticons such as “ :-(”, and the like. For example, “The delivery delay is going to be an obstacle for us.” would yield a “bad” sentiment score of minus two or minus three.

In an embodiment, optimize program 134, based on NLP and cognitive analysis, determines a sentiment score of minus four or minus five when the following words or phrases are included in the electronic communication(s): customer issue, very bad, extremely negative, unexceptional, exceedingly poor, failing, highly inferior, particularly awful, large problem, big obstacle, depressed, and the like. For example, “This customer issue may lose us the next bid opportunity.” would yield a “very bad” sentiment score of minus four or minus five.

In an embodiment, a sentiment score of minus two or minus three may be considered “bad”. In another embodiment, a sentiment score of minus four or minus five may be considered “very bad”. In yet another embodiment, a sentiment score of minus two, minus three, minus four, or minus five may be considered “red”.

In an embodiment, a first threshold and a second threshold may be defined by a user. In an embodiment, an overall sentiment score above the first threshold may be considered “positive” and an overall sentiment score below the second threshold may be considered “negative”. For example, with an assigned first threshold of plus one, an overall sentiment score of plus two for a group of e-mails would result in a “positive” overall sentiment. Continuing the example, with an assigned second threshold of minus one, an overall sentiment score of minus two for another group of e-mails would result in a “negative” overall sentiment.

In an embodiment, the overall sentiment score is an average of the individual sentiment scores for the monitored electronic communications. For example, if three separate electronic communications have individual sentiment scores of plus one, plus five, and minus two, the overall sentiment score is the average of plus one, plus five, and minus two, which equals plus one and one-third which would be rounded to plus one.

In another embodiment, the overall sentiment score is a weighted average of the individual sentiment scores. In the embodiment, sentiment scores of plus four, plus five, minus four, and minus five are weighted because they are considered more extreme than other sentiment scores. In the embodiment, the weighting may be done by a user or by optimize program 134. For example, if a user assigns a weighting factor of one hundred and twenty percent to extreme (i.e., plus four, plus five, minus four, and minus five) sentiment scores, the overall sentiment score in the above example (three scores of plus one, plus five, and minus two), the overall sentiment score equals one and two-thirds which would be rounded to plus two.

In yet another embodiment, the overall sentiment score may be weighted such that a trend analysis is included. For example, a first electronic communication may have a sentiment score of plus two, a second electronic communication may have a sentiment score of zero, and a third electronic communication may have a sentiment score of minus two. In this example, the electronic communications are chronological and are sent from the same person to same group of people. If the overall sentiment score is a simple average of individual sentiment score, the overall sentiment score would be zero and the sentiment would be neutral. However, weighting the individual sentiment scores based on trending over time may conclude that the overall sentiment is bad based on the individual sentiment scores trending down over time (i.e., plus two to zero to minus two).

In yet another embodiment, the overall sentiment score is simply the highest or lowest individual sentiment score over a pre-determined period of time (i.e., one week, two weeks, one month, etc.). If over the pre-determined period of time, the highest and lowest individual sentiment scores cancel out, the next highest or lowest individual sentiment score would be the overall sentiment score. For example, if the pre-determined period of time was one week and three individual sentiment scores were determined to be plus five, plus four, and minus five, the overall sentiment score would be plus four.

In yet another embodiment, individual sentiment scores may be weighted based on the position of the sender. For example, an employee sentiment score may not be weighted but a sentiment score for an electronic communication for a manager may be weighted by a factor of one hundred ten percent and that of a senior manager may be weighted by a factor of one hundred twenty percent.

In an embodiment, optimize program 134 determines whether the overall sentiment score is “neutral” (decision step 212). In other words, optimize program 134 determines whether the overall sentiment score determined in step 210 is considered “neutral”. In an embodiment, the determination is made by comparing the overall sentiment score to a “good”, “neutral”, or “bad” classification. For example, a “green” score is considered “good”, a “yellow” score is considered “neutral”, and a “red” score is considered “bad”. In another example, an overall sentiment score of plus five, plus four, plus three, or plus two is considered “good”, an overall sentiment score of plus one, zero, or minus one is considered “neutral”, and an overall sentiment score of minus two, minus three, minus four, or minus five is considered “bad”. In one embodiment (decision step 212, YES branch), the overall sentiment score is considered “neutral”; therefore, optimize program 134 proceeds to step 220 to store information. In the embodiment (decision step 212, NO branch), the overall sentiment score is not considered “neutral”; therefore, optimize program 134 proceeds to decision step 214.

In an embodiment, optimize program 134 determines whether the overall sentiment score is “good” (decision step 214). In other words, responsive to determining that the overall sentiment score is not “neutral”, optimize program 134 determines whether the overall sentiment score is “good”. In one embodiment (decision step 214, YES branch), optimize program 134 determines that the overall sentiment score is “good”; therefore, optimize program 134 proceeds to step 218 to recommend an adjustment to the meeting. In the embodiment (decision step 214, NO branch), optimize program 134 determines that the overall sentiment score is not “good”; therefore, optimize program 134 proceeds to step 216.

In an embodiment, optimize program 134 determines new people (step 216). In other words, responsive to determining that the overall sentiment score is not “good”, optimize program 134 determines new people to invite to the meeting. In an embodiment, NLP is used to evaluate the electronic communication to determine the new people to invite. For example, NLP may recognize that technology “XYZ” is discussed in the electronic communication and therefore, optimize program 134 may invite a subject matter expert on technology “XYZ” to the meeting. In another embodiment, optimize program 134, based on an NLP evaluation, may invite a higher level of management to the meeting if the NLP evaluation determines that a particular issue has persisted over the course of several meetings. In yet another embodiment, optimize program 134, based on an NLP evaluation of electronic communication between teams, may invite only team leads to a meeting rather than including all of the team members. In an embodiment, optimize program 134 may use a company employee directory or historical information in order to determine the correct new people to invite to the meeting. In yet another embodiment, optimize program 134, based on an NLP evaluation, may determine that another organization, such as Human Resources or Safety, should be invited to the meeting in order to answer specific questions that may need to be answered in the meeting. In an embodiment, optimize program 134 on computing device 130 determines that the second line manager of two employees should be invited to the meeting to help resolve an issue between the two employees that has not been resolved for the last two meetings. For example, “Jim”, the second line manager of “Ann” and “Cal”, should be invited to the weekly status meeting in order to help resolve an ongoing issue between “Ann” and “Cal”.

In an embodiment, optimize program 134 recommends an adjustment (step 218). In other words, responsive to (a) determining that the overall sentiment score is “good” (decision step 214) or (b) determining new people (step 216), optimize program 134 recommends an adjustment to the meeting to the meeting owner. In an embodiment, recommended adjustments may include cancelling the meeting, shortening the meeting, lengthening the meeting, scheduling a new meeting, changing the type of meeting (e.g., from a videoconference to a face-to-face meeting, from a group meeting to a one-on-one meeting, etc.), and inviting new attendees to an existing meeting. In an embodiment, the recommendation is sent to only the meeting owner. In another embodiment, the recommendation is sent to the meeting owner and the invitees to the meeting. In yet another embodiment, the recommendation is sent to any combination of the meeting owner, the invitees to the meeting, and to any determined new people to be invited to the meeting. In an embodiment, optimize program 134 on computing device 130 recommends to a meeting owner on user device 120-N that the meeting should be extended by thirty minutes. For example, “Ann” is the owner of the hour long weekly status meeting and “Ann” receives a recommendation to change the next meeting to a duration of ninety minutes.

In an embodiment, optimize program 134 stores information (step 220). In other words, optimize program 134 stores the information from determining that the overall sentiment score was either “neutral”, “good”, or not “good”. In an embodiment, the information may include the determined overall sentiment score, the cognitive analysis and NLP of the electronic communication used to determine the overall sentiment score, the specific electronic communication(s), and the recommended adjustment(s), if any, for the meeting. In an embodiment, optimize program 134 stores the determined overall sentiment score, the cognitive analysis and NLP analysis of the electronic communication used to determine the overall sentiment score, the specific electronic communication(s), and the recommended adjustment to the meeting to information repository 132 on computing device 130. For example, regarding the weekly status meeting owned by “Ann”, the following information is stored: the overall sentiment score of minus four, the monitored and stored electronic communication concerning the weekly status meeting, the recommendation to extend the meeting to ninety minutes, and the recommendation to invite “Jim” to the meeting to help resolve the issue between “Ann” and “Cal”.

FIG. 3 depicts computer system 300, which is an example of a system that includes optimize program 134. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. 1/0 interface(s) 306 also connect to display 309.

Display 309 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for optimizing meeting schedules based on sentiment analysis of electronic communication, the method comprising:
receiving, by one or more computer processors, an input from a user, wherein the input from the user includes two or more first users, a time frame for monitoring one or more first electronic communications between the two or more first users, and a method for determining an overall sentiment score of the one or more first electronic communications;
monitoring, by one or more computer processors, the one or more first electronic communications between the two or more first users during the time frame;
determining, by one or more computer processors, one or more related first electronic communications in the one or more first electronic communications, wherein the determination is done using cognitive analysis and natural language processing analysis of the one or more first electronic communications;
determining, by one or more computer processors, a meeting in the determined one or more related first electronic communications; and
determining, by one or more computer processors, an overall sentiment score for the determined meeting.

2. The method of claim 1, further comprising:
determining, by one of more computer processors, that the overall sentiment score for the determined meeting is above a first threshold; and
responsive to determining that the overall sentiment score for the determined meeting is above the first threshold, recommending, by one or more computer processors, an adjustment to an owner of the determined meeting.

3. The method of claim 1, further comprising:
determining, by one of more computer processors, that the overall sentiment score for the determined meeting is below a second threshold; responsive to determining that the overall sentiment score for the determined meeting is below a second threshold, determining, by one or more computer processors, one or more new people to invite to the determined meeting;
providing, by one or more computer processors, an indication to an owner of the determined meeting, wherein the indication includes the one or more new people to the determined meeting; and
recommending, by one or more computer processors, an adjustment to the owner of the determined meeting.

4. The method of claim 2, wherein the recommended adjustment to the owner of the determined meeting is selected from the group consisting of cancelling the determined meeting, shortening the determined meeting, lengthening the determined meeting, scheduling a new meeting, and changing a type of meeting for the determined meeting.

5. The method of claim 1, wherein the method of determining an overall sentiment score is selected from the group consisting of an average of two or more individual sentiment scores for the one or more related electronic communications, a weighted average of the two or more individual sentiment scores for the one or more related electronic communications, an average of the two or more individual sentiment scores for the one or more related electronic communications weighted with a trend analysis over a period of time, a highest or lowest individual sentiment score of the two or more individual sentiment scores for the one or more related electronic communications over a pre-determined period of time, and a weighted average of the two or more individual sentiment scores for the one or more related electronic communications, wherein the weighting is based on a position of a sender of the one or more related electronic communications.

6. The method of claim 1, wherein the step of determining, by one or more computer processors, an overall sentiment score for the determined meeting, comprises:
determining, by one or more computer processors, one or more first words in the determined one or more related first electronic communications, wherein the one or more first words are determined to be positive based on analyzing the one or more first words in the determined one or more related first electronic communications using natural language processing and cognitive analysis with machine learning algorithms;
assigning, by one or more computer processors, a positive sentiment score to each word in the one or more first words based on natural language processing and cognitive analysis with machine learning algorithms;
determining, by one or more computer processors, one or more second words in the determined one or more related first electronic communications, wherein the one or more second words are determined to be negative based on analyzing the one or more second words in the determined one or more related first electronic communications using natural language processing and cognitive analysis with machine learning algorithms;
assigning, by one or more computer processors, a negative sentiment score to each word in the one or more first words based on natural language processing and cognitive analysis with machine learning algorithms;
determining, by one or more computer processors, a sentiment score for each communication in the one or more related communications, wherein the determination is made by averaging the positive sentiment score for each word in each communication of the one or more related communications and the negative sentiment score for each word in each communication of the one or more related communications; and
determining, by one or more computer processors, an overall sentiment score for the determined meeting, wherein the overall sentiment score is an average of the positive sentiment scores and the negative sentiment scores for each communication in the one or more related communications.

7. The method of claim 1, further comprising:
providing, by one or more computer processors, the determined overall sentiment score to the owner of the determined meeting.

8. A computer program product for optimizing meeting schedules based on sentiment analysis of electronic communication, the computer program product comprising:
one or more computer readable storage media; and
program instructions stored on the one or more computer readable storage media, the program instructions comprising:
program instructions to receive an input from a user, wherein the input from the user includes two or more first users, a time frame for monitoring one or more first electronic communications between the two or more first users, and a method for determining an overall sentiment score of the one or more first electronic communications;
program instructions to monitor the one or more first electronic communications between the two or more first users during the time frame;
program instructions to determine one or more related first electronic communications in the one or more first electronic communications, wherein the determination is done using cognitive analysis and natural language processing analysis of the one or more first electronic communications;
program instructions to determine a meeting in the determined one or more related first electronic communications; and
program instructions to determine an overall sentiment score for the determined meeting.

9. The computer program product of claim 8, further comprising program instructions stored on the one or more computer readable storage media, to:
determine that the overall sentiment score for the determined meeting is above a first threshold; and
responsive to determining that the overall sentiment score for the determined meeting is above the first threshold, recommend an adjustment to an owner of the determined meeting.

10. The computer program product of claim 8, further comprising program instructions stored on the one or more computer readable storage media, to:
determine that the overall sentiment score for the determined meeting is below a second threshold;
responsive to determining that the overall sentiment score for the determined meeting is below a second threshold, determine one or more new people to invite to the determined meeting;
provide an indication to an owner of the determined meeting, wherein the indication includes the one or more new people to the determined meeting; and
recommend an adjustment to the owner of the determined meeting.

11. The computer program product of claim 9, wherein the recommended adjustment to the owner of the determined meeting is selected from the group consisting of cancelling the determined meeting, shortening the determined meeting, lengthening the determined meeting, scheduling a new meeting, and changing a type of meeting for the determined meeting.

12. The computer program product of claim 8, wherein the method of determining an overall sentiment score is selected from the group consisting of an average of two or more individual sentiment scores for the one or more related electronic communications, a weighted average of the two or more individual sentiment scores for the one or more related electronic communications, an average of the two or more individual sentiment scores for the one or more related electronic communications weighted with a trend analysis over a period of time, a highest or lowest individual sentiment score of the two or more individual sentiment scores for the one or more related electronic communications over a pre-determined period of time, and a weighted average of the two or more individual sentiment scores for the one or more related electronic communications, wherein the weighting is based on a position of a sender of the one or more related electronic communications.

13. The computer program product of claim 8, wherein the program instructions to determine an overall sentiment score for the determined meeting, comprises:
program instructions to determine one or more first words in the determined one or more related first electronic communications, wherein the one or more first words are determined to be positive based on analyzing the one or more first words in the determined one or more related first electronic communications using natural language processing and cognitive analysis with machine learning algorithms;
program instructions to assign a positive sentiment score to each word in the one or more first words based on natural language processing and cognitive analysis with machine learning algorithms;
program instructions to determine one or more second words in the determined one or more related first electronic communications, wherein the one or more second words are determined to be negative based on analyzing the one or more second words in the determined one or more related first electronic communications using natural language processing and cognitive analysis with machine learning algorithms;
program instructions to assign a negative sentiment score to each word in the one or more first words based on natural language processing and cognitive analysis with machine learning algorithms;
program instructions to determine a sentiment score for each communication in the one or more related communications, wherein the determination is made by averaging the positive sentiment score for each word in each communication of the one or more related communications and the negative sentiment score for each word in each communication of the one or more related communications; and
program instructions to determine an overall sentiment score for the determined meeting, wherein the overall sentiment score is an average of the positive sentiment scores and the negative sentiment scores for each communication in the one or more related communications.

14. The computer program product of claim 8, further comprising program instructions stored on the one or more computer readable storage media, to:
provide the determined overall sentiment score to the owner of the determined meeting.

15. A computer system for optimizing meeting schedules based on sentiment analysis of electronic communication, the computer system comprising:
one or more computer processors;
one or more computer readable storage media; and
program instructions stored on the one or more computer readable storage media for execution by at least one of the one or more computer processors, the program instructions comprising:
program instructions to receive an input from a user, wherein the input from the user includes two or more first users, a time frame for monitoring one or more first electronic communications between the two or more first users, and a method for determining an overall sentiment score of the one or more first electronic communications;
program instructions to monitor the one or more first electronic communications between the two or more first users during the time frame;
program instructions to determine one or more related first electronic communications in the one or more first electronic communications, wherein the determination is done using cognitive analysis and natural language processing analysis of the one or more first electronic communications;
program instructions to determine a meeting in the determined one or more related first electronic communications; and
program instructions to determine an overall sentiment score for the determined meeting.

16. The computer system of claim 15, further comprising program instructions stored on the one or more computer readable storage media for execution by at least one of the one or more computer processors, to:
determine that the overall sentiment score for the determined meeting is above a first threshold; and
responsive to determining that the overall sentiment score for the determined meeting is above the first threshold, recommend an adjustment to an owner of the determined meeting.

17. The computer system of claim 15, further comprising program instructions stored on the one or more computer readable storage media for execution by at least one of the one or more computer processors, to:
determine that the overall sentiment score for the determined meeting is below a second threshold;
responsive to determining that the overall sentiment score for the determined meeting is below a second threshold, determine one or more new people to invite to the determined meeting;
provide an indication to an owner of the determined meeting, wherein the indication includes the one or more new people to the determined meeting; and
recommend an adjustment to the owner of the determined meeting.

18. The computer system of claim 16, wherein the recommended adjustment to the owner of the determined meeting is selected from the group consisting of cancelling the determined meeting, shortening the determined meeting, lengthening the determined meeting, scheduling a new meeting, and changing a type of meeting for the determined meeting.

19. The computer system of claim 15, wherein the method of determining an overall sentiment score is selected from the group consisting of an average of two or more individual sentiment scores for the one or more related electronic communications, a weighted average of the two or more individual sentiment scores for the one or more related electronic communications, an average of the two or more individual sentiment scores for the one or more related electronic communications weighted with a trend analysis over a period of time, a highest or lowest individual sentiment score of the two or more individual sentiment scores for the one or more related electronic communications over a pre-determined period of time, and a weighted average of the two or more individual sentiment scores for the one or more related electronic communications, wherein the weighting is based on a position of a sender of the one or more related electronic communications.

20. The computer system of claim 15, wherein the program instructions to determine an overall sentiment score for the determined meeting, comprises:
program instructions to determine one or more first words in the determined one or more related first electronic communications, wherein the one or more first words are determined to be positive based on analyzing the one or more first words in the determined one or more related first electronic communications using natural language processing and cognitive analysis with machine learning algorithms;
program instructions to assign a positive sentiment score to each word in the one or more first words based on natural language processing and cognitive analysis with machine learning algorithms;
program instructions to determine one or more second words in the determined one or more related first electronic communications, wherein the one or more second words are determined to be negative based on analyzing the one or more second words in the determined one or more related first electronic communications using natural language processing and cognitive analysis with machine learning algorithms;
program instructions to assign a negative sentiment score to each word in the one or more first words based on natural language processing and cognitive analysis with machine learning algorithms;
program instructions to determine a sentiment score for each communication in the one or more related communications, wherein the determination is made by averaging the positive sentiment score for each word in each communication of the one or more related communications and the negative sentiment score for each word in each communication of the one or more related communications; and
program instructions to determine an overall sentiment score for the determined meeting, wherein the overall sentiment score is an average of the positive sentiment scores and the negative sentiment scores for each communication in the one or more related communications.
